(19) United States
(12) Patent Application Publication
(10) Pub. No.: US 2026/0178578 A1
(43) Pub. Date: Jun. 25, 2026

(54) SYSTEMS AND METHOD FOR GENERATIVE ARTIFICIAL INTELLIGENCE-BASED INCIDENTS MANAGEMENT

(71) Applicant: JPMORGAN CHASE BANK, N.A., New York, NY (US)

(72) Inventors: Najah GHALYAN, Wayne, NJ (US); Mohammed AYUB, Jersey City, NJ (US); Sean GUARNACCIO, Morristown, NJ (US); Franco HORISBERGER, Villa del Parque (AR); Jialei SHI, London (GB); Senad IBRAIMOSKI, London (GB); Zafer ERDOGAN, London (GB); Sabrina WALKER, Buenos Aires (AR); Alejandro CARRASCOSA, Buenos Aires (AR); Edward FUNNELL, Lymington (GB); Sean MORAN, London (GB); Jonathan BURGIN, Highcliffe (GB)

(21) Appl. No.: 19/001,084

(22) Filed: Dec. 24, 2024

(51) Int. Cl. G06F 16/2453; G06F 16/2455

(52) U.S. Cl. CPC G06F 16/24534; G06F 16/2455

(57) ABSTRACT

Systems and methods for generative artificial intelligence-based incidents management are disclosed. A method may include: receiving a user query from a user interface computer program executed by a user electronic device; determining that the user query is ambiguous; providing the user query to a disambiguation agent, wherein the disambiguation agent returns a plurality of disambiguated user queries for the user query; presenting the plurality of disambiguated user queries to the user interface computer program; receiving a selection of one of the disambiguated user queries from the user interface computer program; generating Structured Query Language (SQL) for the selected disambiguated user query; executing the SQL for the selected disambiguated user query on a database; and returning results of the execution of the SQL for the selected disambiguated user query on the database to the user interface computer program.

### BACKGROUND OF THE INVENTION

### 1. Field of the Invention

Embodiments generally relate to systems and methods for generative artificial intelligence-based incidents management.

### 2. Description of the Related Art

Retrieving change incident records is a crucial step in diagnosing various incidents and identifying potential root causes. Typically, when an incident occurs, a filtering tool is used to gather change incident records from different tables across multiple databases. This helps the support team determine the root cause of the incidents. The filtering tool, however, is limited in that it cannot leverage the text data within change incident records, which could provide valuable insights for root cause analysis. This limitation can make root cause analysis challenging and may lead to prolonged service disruptions for related applications. Users often face difficulties when tasked with navigating long or detailed lists or tables of information to determine which items might have a causal relationship with the incident at hand.

### SUMMARY OF THE INVENTION

Systems and methods for generative artificial intelligence-based incidents management are disclosed. According to an embodiment, a method may include: (1) receiving, by a computer program executed by a backend electronic device, a user query from a user interface computer program executed by a user electronic device; (2) determining, by the computer program, that the user query is ambiguous; (3) providing, by the computer program, the user query to a disambiguation agent, wherein the disambiguation agent returns a plurality of disambiguated user queries for the user query; (4) presenting, by the computer program, the plurality of disambiguated user queries to the user interface computer program; (5) receiving, by the computer program, a selection of one of the disambiguated user queries from the user interface computer program; (6) generating, by the computer program, Structured Query Language (SQL) for the selected disambiguated user query; (7) executing, by the computer program, the SQL for the selected disambiguated user query on a database; and (8) returning, by the computer program, results of the execution of the SQL for the selected disambiguated user query on the database to the user interface computer program.

In one embodiment, the user query is ambiguous when it is susceptible to a plurality of interpretations.

In one embodiment, the step of determining, by the computer program, that the user query is ambiguous may include: generating, by the computer program, a first prompt with the user query asking a large language model (LLM) whether the user query is ambiguous; and submitting, by the computer program, the first prompt to the LLM; wherein the LLM returns an indication of whether the user query is ambiguous.

In one embodiment, the step of providing, by the computer program, the user query to the disambiguation agent may include: generating, by the computer program, a second prompt comprising the user query and a request for the LLM to return the plurality of disambiguated queries; and submitting, by the computer program, the second query to the LLM; wherein the LLM returns the plurality of disambiguated queries.

In one embodiment, the second prompt may also include rules for returning the disambiguated queries.

In one embodiment, the rules identify words or phrases in the user query that are not ambiguous.

In one embodiment, the rules may be derived from a plurality of past user queries statistically.

In one embodiment, the rules may be based on a pattern identified in past user queries.

In one embodiment, the rules may be identified using machine learning.

In one embodiment, the method may also include: causing, by the computer program, a downstream system to take an action in response to the results of the execution of the SQL for the selected disambiguated user query.

According to another embodiment, a non-transitory computer readable storage medium, may include instructions stored thereon, which when read and executed by one or more computer processors, cause the one or more computer processors to perform steps comprising: receiving a user query from a user interface computer program executed by a user electronic device; determining that the user query is ambiguous; providing the user query to a disambiguation agent, wherein the disambiguation agent returns a plurality of disambiguated user queries for the user query; presenting the plurality of disambiguated user queries to the user interface computer program; receiving a selection of one of the disambiguated user queries from the user interface computer program; generating Structured Query Language (SQL) for the selected disambiguated user query; executing the SQL for the selected disambiguated user query on a database; and returning results of the execution of the SQL for the selected disambiguated user query on the database to the user interface computer program.

In one embodiment, the user query is ambiguous when it is susceptible to a plurality of interpretations.

In one embodiment, the instructions for determining that the user query is ambiguous may also include instructions stored thereon, which when read and executed by the one or more computer processors, cause the one or more computer processors to perform steps comprising: generating a first prompt with the user query asking a large language model (LLM) whether the user query is ambiguous; submitting the first prompt to the LLM; and receiving, from the LLM, an indication of whether the user query is ambiguous.

In one embodiment, the instructions for providing the user query to the disambiguation agent includes instructions stored thereon, which when read and executed by the one or more computer processors, cause the one or more computer processors to perform steps comprising: generating a second prompt comprising the user query and a request for the LLM to return the plurality of disambiguated queries; submitting the second query to the LLM; and receiving, from the LLM, the plurality of disambiguated queries.

In one embodiment, the second prompt may also include rules for returning the disambiguated queries.

In one embodiment, the rules identify words or phrases in the user query that are not ambiguous.

In one embodiment, the rules may be derived from a plurality of past user queries statistically.

In one embodiment, the rules may be based on a pattern identified in past user queries.

In one embodiment, the rules may be identified using machine learning.

In one embodiment, the non-transitory computer readable storage medium may also include instructions stored thereon, which when read and executed by the one or more computer processors, cause the one or more computer processors to perform steps comprising: causing a downstream system to take an action in response to the results of the execution of the SQL for the selected disambiguated user query.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for generative artificial intelligence-based incidents management according to an embodiment;

FIG. 2 depicts a method for generative artificial intelligence-based incidents management according to an embodiment;

FIG. 3 depicts an exemplary computing system for implementing aspects of the present disclosure.

### DETAILED DESCRIPTION OF PREFERRED EMBODIMENTS

Embodiments generally relate to systems and methods for generative artificial intelligence-based incidents management.

The incident management process is a critical component of information technology (or “IT”) service management, encompassing the detection, diagnosis, mitigation, and resolution of incidents to ensure system reliability and minimize impact duration. The use of generative artificial intelligence (AI) offers transformative potential, enhancing efficiency, accuracy, and speed across all stages in the process.

In the detection phase, embodiments may continuously monitor ongoing change requests and identify those with the highest risk of causing potential incidents. Embodiments may leverage machine learning algorithms to identify similarities between causes of past incidents and current change requests ensuring proper steps are taken to avoid potential incidents.

During the diagnosis phase, embodiments may analyze vast amounts of data to identify patterns and correlations that may point to the root cause of an incident (for example, a causal change record). Natural Language Processing (NLP) capabilities enable the AI to sift through historical incident reports, knowledge bases, and documentation to provide insights and recommendations. This accelerates the diagnostic process and enhances the accuracy of root cause identification.

In the mitigation phase, embodiments may suggest and may automate initial response actions to contain the incident. Examples of initial response actions may include isolating affected systems, applying temporary patches, adjusting network configurations, etc. in order to prevent the incident from escalating. These automated responses may be based on predefined rules and real-time data analysis, ensuring swift and effective containment.

In the resolution phase, embodiments may assist in developing and implementing a permanent fix. By analyzing the effectiveness of past resolutions and considering the current context, embodiments may use AI to recommend the most appropriate course of action.

In addition, embodiments may automate the documentation of the incident resolution process, ensuring that all steps are recorded for future reference and compliance purposes.

Embodiments may enhance the detection, diagnosis, mitigation, and resolution of incidents more efficiently and accurately. This leads to reduced impact duration, improved system reliability, and a more resilient technology.

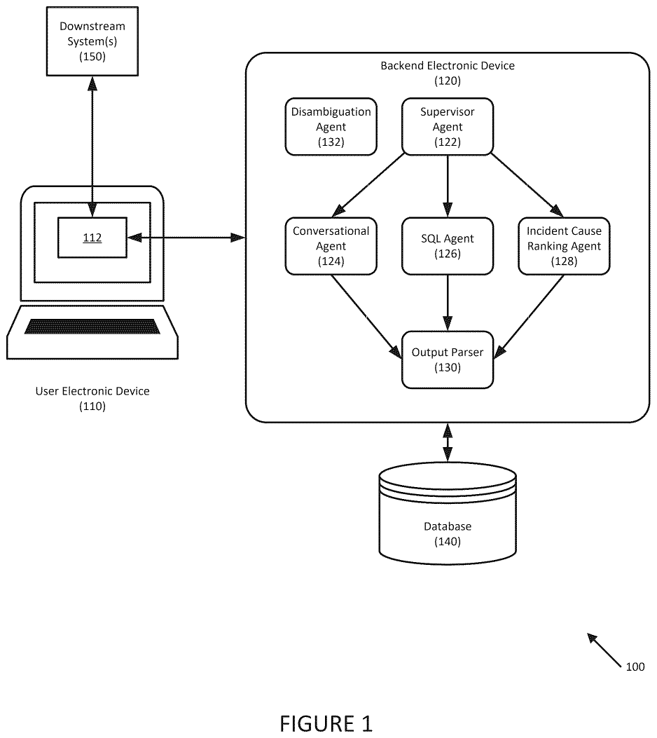

FIG. 1 depicts a system for generative artificial intelligence-based incidents management according to an embodiment. System 100 may include user electronic device 110, which may be a computer (e.g., workstation, desktop, laptop, notebook, tablet, etc.), smart device (e.g., smart phone, smart watch, etc.), an Internet of Things (IoT) appliance, etc. User electronic device 110 may further include a computer accessing a server (not shown) using a browser or application.

User electronic device may execute user computer program 112, which may receive a user query. User computer program 112 may be a program, an application, a browser, etc.

User computer program 112 may interface with backend electronic device 120, which may include supervisor agent 122, conversation agent 124, Structured Query Language (SQL) agent 126, incident cause ranking agent 128, and output parser 130. Supervisor agent 122, conversation agent 124, SQL agent 126, incident cause ranking agent 128, and output parser 130 may be computer programs that may be executed by backend electronic device 120, such as a server (e.g., physical and/or cloud-based), computers, etc.

Supervisor agent 122 may be an agent that routes a user query to the correct agent (e.g., conversation agent 124, SQL agent 126, or incident cause ranking agent 128) based on a semantic understanding of the user query and chat history.

Disambiguation agent 132 may be an agent that identifies potential ambiguities in user query to ensure best results from a SQL query. Disambiguation agent 132 may be a LLM-based module.

Disambiguation agent 132 may receive the user query and may analyze the user query for ambiguities. A user query may be ambiguous when it is susceptible to more than one interpretation. If the user query is ambiguous, disambiguation agent 132 may return a list of disambiguated questions to the user, and the user may review the list of disambiguated questions and select one of the disambiguated questions for submission for processing. If none of the disambiguated questions is acceptable, the user may enter a new user query.

In one embodiment, disambiguation agent 132 may use historical data, such as historical user queries in an embedding space, and may compare an input, such as current user query, to the embedding space. The embedding space may include clusters of historical user queries. The current user query embedding may be compared to the cluster, and a LLM may be used to identify question(s) that may be helpful in moving the current user query embedding into one of the clusters.

In one embodiment, the LLM may summarize the topics for each historical user query cluster, and the LLM may be prompted with the summaries and the current user query to suggest a question to ask the user that would move the current user query into one of the summaries.

The user's answer may be used to update the original user query, thereby removing the ambiguity.

Conversation agent 124 may be an agent that handles any user query not specifically related to Change Requests/Incident Management.

SQL agent 126 may be an agent that processes the user's natural language query to SQL and executes the SQL query against database 140.

Incident cause ranking agent 128 may be an agent that may take ongoing incident details and provide a ranked list of potential causes for investigation.

Output parser 130 may standardize the responses from conversation agent 124, SQL agent 126, and incident cause ranking agent 128 and return a response to the user.

Database 140 may be a SQL database.

System 100 may further include one or more downstream systems 150, which may be systems that are controlled following the receipt of the response to the user query. Downstream systems 150 may be controlled to take an action, such as executing an automated change back-out plan; automatically paging and involving the service team responsible for change implementation; triggering applicable business resiliency plans; activating disaster recovery systems; communicating automatically with impacted users; etc.

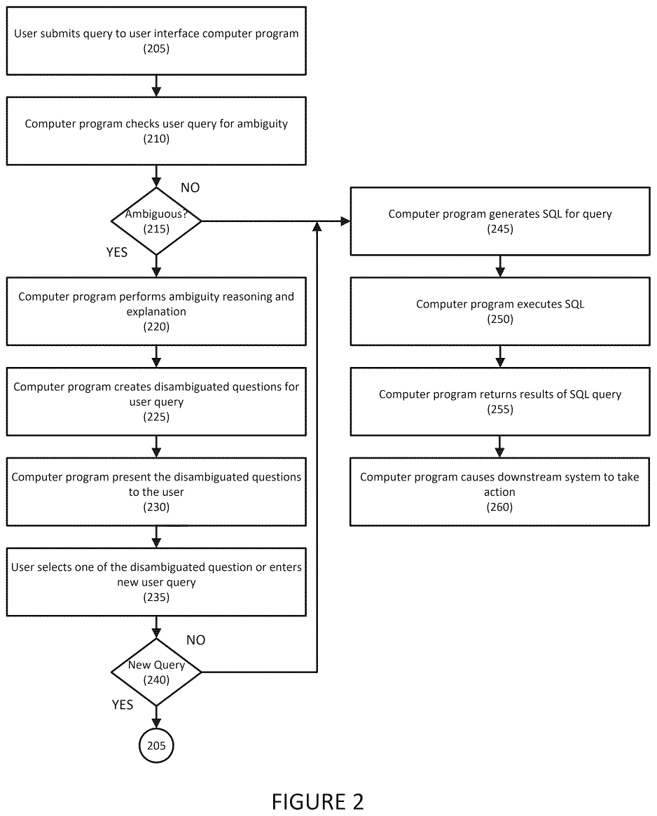

Referring to FIG. 2, a method for generative artificial intelligence-based incidents management according to an embodiment.

In step 205, a user may submit a user query to user interface computer program executed on a user electronic device. The query may be provided to a backend electronic device.

In step 210, a computer program executed by the backend electronic device may check the user query for ambiguity using, for example, a disambiguation agent. For example, the computer program may generate a prompt for the LLM asking if the user query is ambiguous. The user query is ambiguous when it is susceptible to more than one interpretation.

If, in step 215, the user query is ambiguous, in step 220, the computer program may use a disambiguation agent to perform ambiguity reasoning and explanation on the user query.

In step 225, using the disambiguation agent, the computer program may create disambiguated questions for the user query using the LLM. For example, as part of the initial prompt, or as part of the second prompt, the computer program may prompt the LLM to return disambiguated questions for the user query.

In one embodiment, the disambiguation agent may also return the rationale for providing the list of disambiguated questions.

In one embodiment, using the disambiguation agent, the computer program may apply rules to apply to the user query to identify the most likely explanations of the user query. For example, the disambiguation agent may include rules in the prompt in one of the prompts to the LLM and may have the LLM return rank the disambiguated questions based on the rules. Prompt engineering may be used to provide the rules to the LLM.

For example, the rules may be domain-specific rules that cannot be garnered from database information only. Examples of rules in an information technology environment may include: (1) checking if there are “incidents,” “major incidents,” “changes,” or “change records” in the user query, as incidents and changes should not be ambiguous (e.g., when someone refers to a change or incident it is understood to refer to the Change Record/Incident Record, as necessary); use the database schema to check for column headers, but ignore a change incident relation table (e.g., the change incident relation table is to facilitate the relationship between change records and incidents and the values should not lead to an ambiguity).

Additional rules may be derived from the user queries statistically (e.g., certain types of questions asked above a threshold frequency may automatically become a rule), summarized by human (e.g., a subject matter expert may observe patterns from past queries), or summarized/learned by other machine learning or artificial intelligence tools (e.g., an AI summarizer may derive rules from past queries).

The LLM may return a ranked list of disambiguated questions to the disambiguation agent based on the rules.

In one embodiment, steps 220 and 225 may be performed in a single prompt to the LLM.

In step 230, the computer program may present the ranked list of disambiguated questions to the user via the user interface computer program.

In step 235, the user may select one of the disambiguated questions via the user interface computer program. If none of the disambiguated questions are acceptable, the user may submit a user query.

In step 240, if the user enters a new user query, the process may return to step 205.

After the user selects one of the suggested queries, or if the user query is not ambiguous, in step 245, the computer program may generate SQL for the user query, and in step 250, may execute the SQL for the user query on a database. For example, the database may include historical incident and change data, and real time incident data.

In step 255, the computer program may return the results of the SQL query to the user. The computer program may rank the results and present them to the user interface.

In step 260, the computer program may use the result of the query may be used to control a downstream system to take one or more actions. Examples of actions may include initiating an automated change back-out plan; automatically paging and involving the service team responsible for change implementation; triggering applicable business resiliency plans; activating disaster recovery systems; communicating automatically with impacted users; etc.

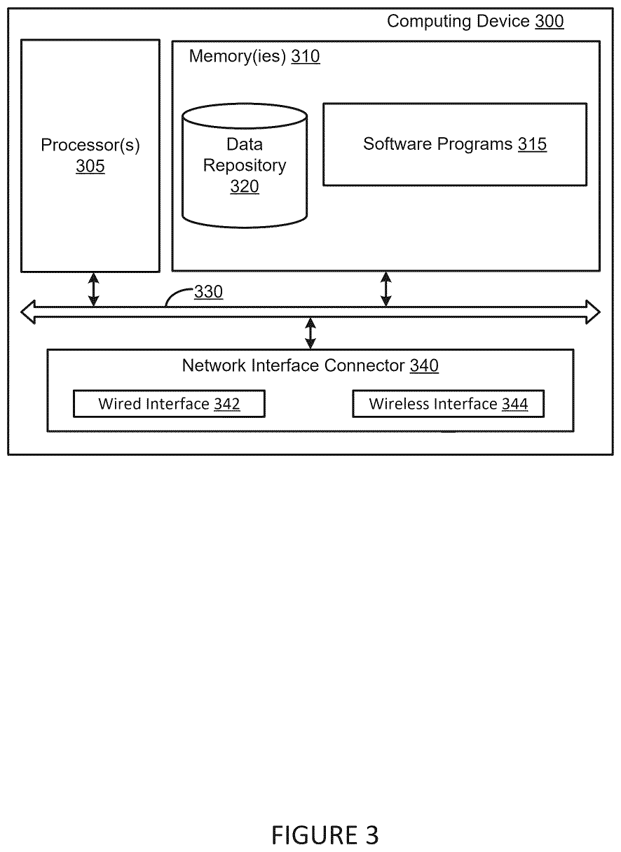

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, by a computer program executed by a backend electronic device, a user query from a user interface computer program executed by a user electronic device;
determining, by the computer program, that the user query is ambiguous by:
generating, by the computer program, a first prompt with the user query asking a large language model (LLM) whether the user query is ambiguous;
submitting, by the computer program, the first prompt to the LLM; and
receiving, by the computer program and from the LLM, an indication of whether the user query is ambiguous;
generating, by the computer program, a second prompt comprising the user query and domain-specific rules for returning disambiguated user queries;
submitting, by the computer program, the second prompt to the LLM;
receiving, by the computer program and from the LLM, a plurality of disambiguated user queries for the user query and a rationale for the plurality of disambiguated user queries based on application of the domain-specific rules;
presenting, by the computer program, the plurality of disambiguated user queries to the user interface computer program;
receiving, by the computer program, a selection of one of the disambiguated user queries from the user interface computer program;
generating, by the computer program, Structured Query Language (SQL) for the selected disambiguated user query;
executing, by the computer program, the SQL for the selected disambiguated user query on a database;
returning, by the computer program, results of the execution of the SQL for the selected disambiguated user query on the database to the user interface computer program; and
causing, by the computer program, a downstream system to take an action in response to the results of the execution of the SQL for the selected disambiguated user query.

2. The method of claim 1, wherein the user query is ambiguous when it is susceptible to a plurality of interpretations.

3-5. (canceled)

6. The method of claim 1, wherein the domain-specific rules identify words or phrases in the user query that are not ambiguous.

7. The method of claim 1, wherein the domain-specific rules are derived from a plurality of past user queries statistically.

8. The method of claim 1, wherein the domain-specific rules are based on a pattern identified in past user queries.

9. The method of claim 1, wherein the domain-specific rules are identified using machine learning.

10. (canceled)

11. A non-transitory computer readable storage medium, including instructions stored thereon, which when read and executed by one or more computer processors, cause the one or more computer processors to perform steps comprising:
receiving a user query from a user interface computer program executed by a user electronic device;
determining that the user query is ambiguous by:
generating a first prompt with the user query asking a large language model (LLM) whether the user query is ambiguous;
submitting the first prompt to the LLM; and
receiving, from the LLM, an indication of whether the user query is ambiguous;
generating a second prompt comprising the user query and domain-specific rules for returning disambiguated user queries;
submitting the second prompt to the LLM;
receiving, from the LLM, a plurality of disambiguated user queries for the user query;
presenting the plurality of disambiguated user queries to the user interface computer program;
receiving a selection of one of the disambiguated user queries from the user interface computer program;
generating Structured Query Language (SQL) for the selected disambiguated user query;
executing the SQL for the selected disambiguated user query on a database;
returning results of the execution of the SQL for the selected disambiguated user query on the database to the user interface computer program; and
causing a downstream system to take an action in response to the results of the execution of the SQL for the selected disambiguated user query.

12. The non-transitory computer readable storage medium of claim 11, wherein the user query is ambiguous when it is susceptible to a plurality of interpretations.

13-15. (canceled)

16. The non-transitory computer readable storage medium of claim 11, wherein the domain-specific rules identify words or phrases in the user query that are not ambiguous.

17. The non-transitory computer readable storage medium of claim 11, wherein the domain-specific rules are derived from a plurality of past user queries statistically.

18. The non-transitory computer readable storage medium of claim 11, wherein the domain-specific rules are based on a pattern identified in past user queries.

19. The non-transitory computer readable storage medium of claim 11, wherein the domain-specific rules are identified using machine learning.

20. (canceled)

21. The method of claim 1, wherein the action comprises:
isolating an affected system.

22. The method of claim 1, wherein the action comprises:
adjusting network configurations for an affected system.

23. The non-transitory computer readable storage medium of claim 11, wherein the action comprises:
isolating an affected system.

24. The non-transitory computer readable storage medium of claim 11, wherein the action comprises:
adjusting network configurations for an affected system.
